(19) United States
(12) Patent Application Publication
(10) Pub. No.: US 2010/0293187 A1
(43) Pub. Date: Nov. 18, 2010

(54) SYSTEM AND METHOD FOR BROADCAST MEDIA TAGGING

(75) Inventors: Rainer Biehn, Ottobrunn (DE); Mathias Küfner, Unterschleissheim (DE); Christian Krapp, Augsburg (DE)

Correspondence Address: KOLISCH HARTWELL, P.C., 200 PACIFIC BUILDING, 520 SW YAMHILL STREET, PORTLAND, OR, 97204, US

(73) Assignee: BAYERISCHE MEDIENTECHNIK GMBH, Munchen (DE)

(21) Appl. No.: 12/665,935

(22) PCT Filed: Jun. 20, 2008
(86) PCT No.: PCT/EP2008/005007

§ 371 Date: Jul. 14, 2010

(30) Foreign Application Priority Data
Jun. 22, 2007 (EP) 07012299.9

(51) Int. Cl. G06F 17/30; G06F 15/16

(52) U.S. Cl. 707/769; 709/231; 707/E17.014

(57) ABSTRACT

The present invention is related to tagging broadcast media, in particular for use in mobile terminals. Metadata related to broadcast video and audio data is transmitted simultaneously within the broadcast packet stream in short intervals in order to allow an exact recognition and immediate recording of single short media objects. These objects may then be sorted based on machine readable category information and used to provide a user specific program.

### RELATED FIELD

This invention is generally related to the field of media broadcasting, and more particular to the tagging of broadcast multimedia streams.

### BACKGROUND ART

Today, a wide variety of media for entertainment and information is available to users. A considerable portion of media content is transmitted via broadcast systems in order to provide information and programs to a large audience. Most important examples of broadcast media are television and radio systems, which are common across the world. While broadcasting allows for receiving different programs on separate channels and usually provides up-to-date information such as latest news and background information on current affairs, the user is bound to the program content and order defined by the broadcast station. Video recorders may be utilized to record a desired program on a storage medium such as a magnetic video cassette or a hard disk for later viewing and/or editing. However, in order to record a program, the user previously needs to check a program guide for items of interest, and to enter a recording time or corresponding codes such as Showview/VCRPlus codes for programming the recorder. This reduces the flexibility and usability of broadcast content to a user, since he cannot select a specific program at any suitable time and might also miss an interesting program item. Furthermore, a user currently has to watch a complete news show or documentary although he may only be interested in a single feature, such as the coverage of a specific sports event.

Broadcast media content may also be received and watched on mobile devices. A mobile media player/recorder may be provided with one or more receiver systems for respective broadcast services, such as DMB or DVB systems supplying digital audio and/or video contents to terminals. With mobile devices, there are several characteristics to be considered.

While a user may rather use a stationary device for watching movies and generally content with longer duration, the typical usage duration for a mobile device is more likely to be around 5 to 15 minutes. When a media object to be viewed is relatively short, the timing for clipping such objects is critical. Also, it is desirable to view up-to-date content, such as the current weather forecast or the morning news. Furthermore, mobile devices may be restricted in view of power supply. Since a receiver consumes a considerable amount of energy, power saving features may be implemented in a mobile device. Another problem is that a user may not always be at a location with optimum radio reception, and the broadcast reception may thus be interrupted when moving around. While systems like EPG (electronic program guide) provide some information on broadcast television content, these are neither very flexible nor exact with regard to the synchronization with the broadcast media stream.

### SUMMARY

A method is described for tagging broadcast media, the method comprising receiving a broadcast media stream including metadata information associated to portions of said stream; extracting said metadata from said media stream; utilizing said metadata for comparing metadata parameters to stored parameters; and recording a portion of said media stream forming a media object in response to a match in said comparing. Metadata related to broadcast video and audio data is transmitted simultaneously within the broadcast packet stream in short intervals in order to allow an exact recognition and immediate recording of single short media objects. These objects may then be sorted based on machine readable category information and used to provide a user specific program.

As the usage patterns of mobile broadcast content is different compared to a stationary environment, the decision on the content to be recorded is based on more general parameters like categories. Thus, users do not have to select specific broadcasted items every day as the categories of interest do not change very often. This raises the usability enormously as no action from the user is necessary. Based on the preferences which have been set once, recordings are made in the background and content is available in unplanned situations which are very common usage patterns for mobile content.

In exemplary embodiments, the metadata may be machine readable.

Preferably the media object is stored together with at least a part of said associated metadata parameters. This allows to use the stored metadata later for sorting, processing, editing or user information.

The metadata may in some embodiments comprise a first parameter table inserted in regular intervals within said media stream. This regular interval may be about 500 ms, or another short interval such that the parameter table is transmitted within a very short time period of start or end of a media object. The metadata may then further comprise a second parameter table including non-time critical information relating to said media object.

With split metadata parameter tables, the comparing may comprise in some embodiments comparing metadata parameters of said first parameter table to stored parameters; recording a portion of said media stream forming a media object in response to a match in said comparing, comparing metadata parameters of said second parameter table to stored parameters; and continuing or cancelling said recording in response to said second comparison.

For example, the first parameter table may include at least a duration of said media object and at least one machine readable content information.

In some embodiments, the metadata may include a location reference for a media description file. Then, the utilizing of said metadata may further comprise extracting said location reference, and retrieving said media description file from said location. The method may also further comprise establishing a transmission connection to the location indicated in said location reference. In this way, the media description file may be transferred via a different transmission medium and does not necessarily have to be inserted into the stream.

The method may in some embodiments further comprise comparing metadata parameters of said media description file to said stored parameters, and recording a portion of said media stream forming a media object in response to a match in said comparing.

According to alternative embodiments, the method may comprise comparing parameters of said media description file to said stored parameters, and determining whether to keep or discard a stored media object based on said media description file. The media description file may in exemplary embodiments also be used for dividing a recorded media object into several smaller media objects in accordance with parameters indicated in said media description file.

In some embodiments, the method may further comprise extracting a media recording forecast from said metadata, and scheduling a recording of one or more media objects based on said media recording forecast.

It may be possible to include into the method deactivating at least a receiver unit until the next scheduled recording, and thus to save energy when no recording is desired.

This scheduling may in some embodiments comprise comparing parameters of said media recording forecast to stored parameters.

The method may further comprise activating said receiver unit in predetermined intervals, and awaiting and receiving said media recording forecast. It is also proposed in some embodiments to maintain said receiver operation without deactivation if a recording is scheduled within a predetermined period of time. When the receiving unit has been deactivated at any time, the method may further comprise reactivating said receiver unit for receiving and encoding said stream slightly before the start time of said scheduled media object to be recorded.

According to some embodiments of the invention, the method may further comprise sorting recorded media objects in accordance with preset preferences. This sorting may for example comprise matching said associated metadata for said media objects to said preset preferences.

Such preset preferences may in example embodiments be provided by an external service provider, be determined based on previous user behaviour, or are set by user input.

The method may further comprise playing at least one of said recorded media objects in response to a request. For playing and/or storing, the method may comprise forming a virtual media channel from said sorted media objects.

The stored parameters for matching may for example be provided by an external service provider, determined based on previous user behaviour, or set by user input.

Furthermore, a method is provided comprising providing a stream including media content for broadcasting including several media objects having a predetermined duration and content; providing metadata related to said media objects; broadcasting said stream together with at least a part of said metadata, wherein at least a part of said metadata is inserted into the stream in regular intervals. The regular interval may for example be wherein approximately 500 ms.

This method may further comprise dividing said metadata into at least two parameter tables, wherein a first parameter table is transmitted in said regular intervals, and wherein said second parameter table includes non-time critical metadata information related to said media objects.

In exemplary embodiments, at least a machine readable duration and content descriptor are included in said first parameter table.

According to further embodiments, the method comprises providing forecast metadata related to media content which is scheduled to be broadcast within a predetermined upcoming time period, and broadcasting said forecast metadata within said stream.

Also, the method may optionally comprise including a location reference into said metadata pointing to an external media description file location.

In some embodiments, the method may further comprise providing and transmitting metadata related to at least one media object which has already been broadcast, wherein said metadata includes a unique identifier for identifying said media object.

It is further provided a system for media broadcast tagging comprising

a broadcast station including a transmission unit adapted to transmit media content in a stream, and a tagging unit adapted to provide metadata related to said media content and to insert at least part of said meta data into said stream at regular intervals;

and at least one receiving terminal including a receiving unit adapted to receive said broadcast stream, a recording unit adapted to obtain said metadata from said broadcast stream, and a storage element for storing selected of said received media content in response to said metadata.

Furthermore, a terminal is proposed comprising a receiving unit adapted to receive a broadcast media stream; an extracting unit adapted to obtain metadata from said broadcast media stream; and a recording unit for recording selected media objects of said received media content on a memory element in response to said metadata. Such a terminal may e.g. be a mobile phone, a mobile media player, a laptop, a personal digital assistant (PDA), or another mobile or also stationary device.

The terminal may further comprise a sorting unit adapted to sort recorded media content based on preset preferences. This sorting unit may for example include a comparing unit adapted to compare said obtained metadata to stored parameters, and to trigger said recording if a match is found by said comparing unit.

### BRIEF DESCRIPTION OF FIGURES

In the following, the invention will be explained by exemplary embodiments and with reference to the appended figures, wherein

FIG. 1 shows an exemplary system according to the invention; and

FIG. 2 is a schematic illustration of a media stream according to the invention.

### DETAILED DESCRIPTION OF EXEMPLARY EMBODIMENTS

Exemplary embodiments of an inventive tagging system and method will now be described in detail. The basic concept is to include metadata tags into a media content stream in order to provide several advantageous features for broadcast receivers. While some of the described features may be adapted to a certain system in these examples or specifically to mobile usage, it is understood that the general concept can similarly be applied to other systems and/or usage situations.

Metadata related to a media stream may fulfill various functions. Several parameters may be combined into metadata to include any desired function. The metadata may for example relate to technical features of the broadcast stream, such as the duration of a media object/program or information on the signal, such as coding and error correction. It may also be related to the content of the media stream, i.e. give a name of the broadcast program item or a description of the topic addressed. The semantic information of a media item may be included in machine readable form for processing and categorizing. Further potential features include information that relates to subsequent processing of the received data stream, such as where to store it, how to handle the stream and for how long it should be stored.

According to an embodiment of the invention, a media stream is divided into single objects. These objects may be defined by the broadcast station and be of any arbitrary length. For user convenience, for example a newscast may be split into several news objects regarding politics, other objects relating to entertainment, some objects related to sports and/or the weather forecast. Each news item may be regarded as a single object, or alternatively several news items may be combined into one object. The division into single media objects may be achieved by setting timestamps and/or marks at certain locations within a data stream. According to an exemplary embodiment, a media key stream MKS is inserted into the transport stream. This media key stream includes information on parts of the actual media stream, such as duration of a media object, and is transmitted in regular intervals. The media key stream MKS is provided as a single packet within the stream. For exact clipping and identification of media objects, the media key stream may be transmitted in very short intervals, such as every 500 ms. This allows immediate access to all relevant information for processing the received broadcast media objects, as will be seen below.

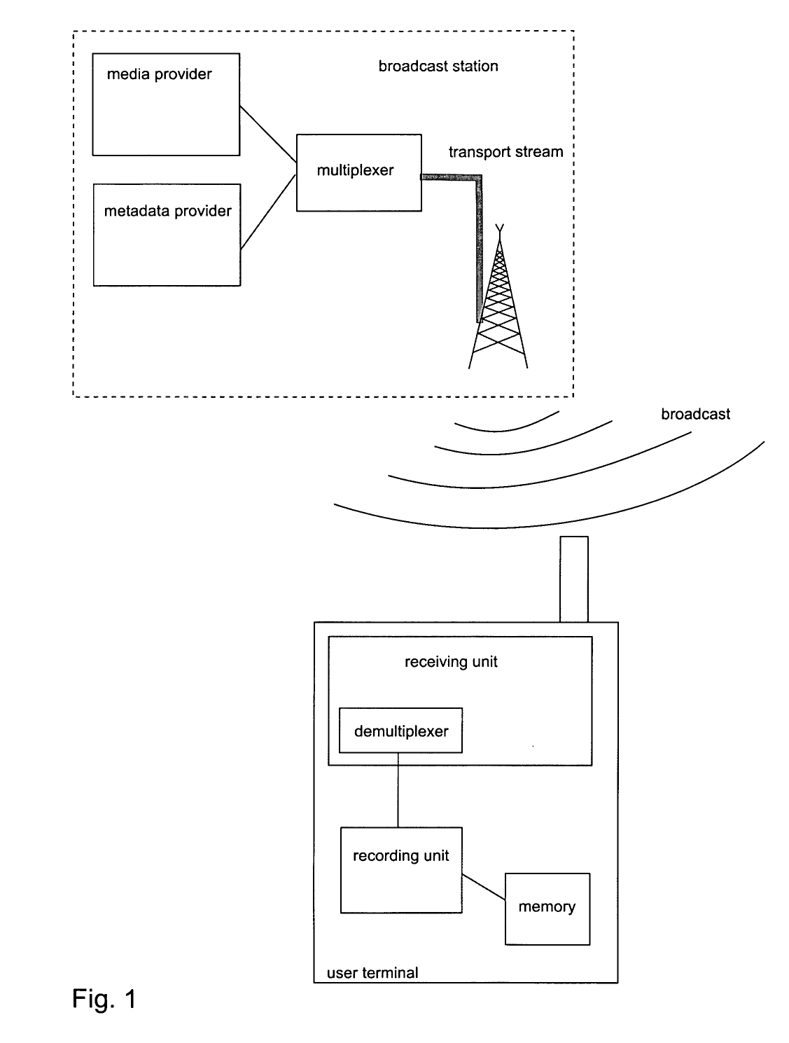

FIG. 1 depicts an exemplary system which may apply the invention. A broadcast station is provided with media content and may prepare this content for broadcasting (e.g. encoding). Audio and/or video data is multiplexed into packets for transmission in a MPEG transport stream TS. Also, a tagging device may be provided which adds tagging data/metadata to the pure audio or video data packets. The actual parameters may in part be determined automatically, such as duration of a media object once it has been defined manually with start point and endpoint. Further parameters such as a category, language or content rating may be entered manually for a media object. It is also conceivable to include this information with a media object already during production of the media content, i.e. recording or cutting, and to store the information in a database. When the media objects are then combined and prepared for broadcasting, all relevant information may be retrieved from the database for integration into the MKS. The provided media content and the further data related to this content are then combined into a transport stream by a multiplexer. Subsequently, the transport stream is sent to a transmitting antenna and broadcast in accordance with the system's specifications. One or more terminals may receive the broadcast signal and retrieve the original data at a demultiplexer. At the terminal, a content monitoring element may be included for scanning the transmitted identifiers and categories included in the metadata packets. User preferences may be stored in a local memory at the terminal, and such preferences may have been entered manually and/or obtained from previous viewing behavior of a user. The content monitoring element will then compare the stored user preferences with parameters given in the broadcast signal for each of the received media objects. When a media object with matching parameters is detected, the content monitoring element may trigger a recording element to start recording of this media object. The recorded stream portion may be stored on a memory device of the terminal. Recorded media objects may then later be combined in any suitable way, either automatically following preset rules or manually by user input, for viewing anywhere and anytime. Further, more complex options of utilizing tagging data will be explained below.

The transmission system used for transferring information from the broadcast station to the terminal(s) may be any suitable broadcast system, such as DVB (digital video broadcasting) transmitted via cable (DVB-C), satellite (DVB-S/-SH), terrestrial antennas (DVB-T), for mobile devices (DVB-H) or via IP-based systems (DVB-IPI), DAB (digital audio broadcasting), or the DMB system (digital multimedia broadcasting) aiming at mobile devices via satellite or terrestrial access (T-/S-DMB).

On the terminal, a software application may be used for performing the sorting and recording of a received media stream. For example, a java-based application may be utilized, such as an application based on Java 2 Micro Edition (J2ME). Many mobile devices such as mobile phones support this application format. A requirement for this may be the implementation of the J2ME APIs JSR-272 (Mobile Broadcast API) to access the broadcasted data and JSR-135 (Multimedia API) for playback and control of audio and video files. However, other formats and interfaces are conceivable as well, and the above are mentioned by way of example only. Another possibility is to use an application based on the operating system of the terminal. This application may be integrated already by a vendor or manufacturer.

For managing user preferences and interest categories, a menu structure may be provided at the terminal. A user may be able to browse through different categories and/or through lists of recorded items within those categories. For example, when one of the recorded media objects is selected at the display, a recording date and time or a short abstract of the media content may be displayed to a user. The user may then select, possibly via another menu, the media object for viewing or listening, or may decide to perform other actions on the media object such as rearranging objects, deleting the object from storage, or adding similar objects to his recording preferences. In a category screen, the user may be able to check categories of interest to define his preferences, such that only objects tagged with the respective category or subcategory will be recorded. Also, the user may select only certain service providers or channels, define languages, or set other restrictions for the recording of objects. One further example is a child safety lock, only allowing to record media content which is tagged for a age specific audience. Further settings which may optionally be controlled by a user include a maximum age of a recorded item, such that a media object will be deleted after expiry of the validity period; a maximum amount of storage capacity used for recorded content; or a sorting/playback order for recorded objects. The metadata used for tagging media objects according to the invention may be included in various descriptors or parameter blocks, which are detailed below.

TABLE 1
MKS parameters

| | | | | | Dynamic (d)/ |
|---|---|---|---|---|---|
| Parameter | | | Description | Occurency | Static (s) |
| Intended Duration | | | Duration before end of effective | 1 | d |
| | | | transmission | | |
| ContinuityCounter | | | Is increased for every new MediaKey | 1 | d |
| Name | | | Short Description | 1 | s |
| Expire Time | | | End of validity of this particular MediaItem; | 0 . . . 1 | d |
| | | | no side effects to children; | | |
| | | | now = delete immediately | | |
| | | | if Expire Time is not used, the MediaItem | | |
| | | | never expires | | |
| MediaIdentifier | Version number | | Increases if content of MI is changed and | 1 | d |
| (MId) | | | Repeat Counter is set to 0. | | |
| | Repeat Counter | | Increases if content is transmitted again | 1 | d |
| | | | without changes | | |
| | ContentID | | ContentIdentifier; must be unique for the | 1 | s |
| | | | content of MI | | |
| IntentionCS | | | | 0 . . . n | d |
| FormatCS | | | | 0 . . . 1 | d |
| ContentCS | | | | 1 . . . n | s |
| IntendedAudienceCS | | | | 0 . . . n | d |
| LanguageCS | | | | 1 . . . n | d |
| MediaTypeCS | | | | 1 | d |
| Abstract | Language | | Long description; Abstract can occur more | 0 . . . n | d |
| | Abstract text | | than once, but only once a language. | | |
| Semantic | | | Describes the semantic meaning of the | 0 . . . 1 | s |
| | | | MediaItem based on properties like | | |
| | | | temporal resolution. | | |
| NumberOfLevels | | | Levels have to be consecutively. Maximum | 1 | s |
| | | | is 5. | | |
| For X=0; | Level | Version | Increases if content of MI is changed and | 1 | s |
| X<NumberOfLevels; | XMedia | number | Repeat Counter is set to 0. | | |
| X++; | Identifier | Repeat | Increases if content is transmitted again | 1 | s |
| | | Counter | without changes | | |
| | | ContentID | ContentIdentifier; must be unique for the | 1 | S |
| | | | content of MI | | |

| | | |
|---|---|---|
| LevelXName | 0 . . . 1 | S |
| LevelXSemantic | 0 . . . 1 | S |

Table 1 indicates exemplary parameters of a media key stream MKS, which is a basic information element including parameters of a currently broadcast media object. The MKS may for example be included into the transmission channel with a repetition rate of 500 ms and thus provide reliable and precise information on the start and end times of a media object. Especially in mobile use this precise timing is important, due to the short usage duration and the even shorter duration of an average media object such as a weather forecast, which will typically be in the order of only a few minutes or less. Imprecise start or end markers would lead to a truncation of the media objects, or require browsing through a recorded object to find the actual start point, and are therefore not acceptable for a user. Based on the regularly transmitted MKS, a terminal receiver or a respective element connected to the receiver is able to detect the boundaries of the media object with sufficient precision. By means of the parameter “Continuity Counter” which is incremented in every transmitted MKS (e.g. every 500 ms), the receiver can evaluate the quality of the received stream and can thus decide whether the reception quality is sufficient to provide a recording of acceptable quality. In case of signal loss or interference, the receiving unit is able to decide whether the recording will not be presented to the user, as incomplete recordings are not acceptable and would decrease the overall acceptance of the tagging service. In contrary to stationary reception where reception quality is quite stable this method is advantageous for mobile systems.

To enhance the precision of timing even further and for optimizing the transmission, the media key stream MKS may optionally also be split into two parts. A first basic MKS_B may carry the most time critical parameters, while remaining parameters are transmitted later in an extended MKS_E. The latter is less time critical and does not always need to be transmitted in the 500 ms-interval as the basic parameters. Preferably, the payload of the basic MKS_B does not exceed the size of one packet, i.e. in the example case of a MPEG transport stream the payload shall be less than 171 Byte for optimized transmission. Examples of non-time critical parameters which may be included in the MKS_E include an expiring time, intention/format/audience descriptors, and the abstract. All further parameters as shown in Table 1 would then be included in the basic MKS_B. Some parameters may be included in both the basic MKS_B and the extended MKS_E media key stream; these are in particular the media identifier MId of the media object which is necessary for identifying the associated object, the semantic meaning of the object, and the hierarchical level structure of the media object. However, the splitting of parameters onto these two metadata packets may also be adapted as desired. In most cases, it will be required to include a start time and at least some content description into the first and regular MKS_B, such that a receiver is able to decide based on this MKS_B whether to start recording (and when) or not. Splitting the MKS may not only be desirable for high precision parameter delivery, but may also depend on the transmission system, that is, on characteristics such as the packet size and multiplexing scheme used for broadcasting. In Table 2, a number of exemplary parameters for basic and extended MKS are shown.

TABLE 2

| | | | |
|---|---|---|---|
| | | | Dynamic (d)/ |
| Parameter | Description | Occurency | Static (s) |

Basic media key stream MKS_B

| Intended Duration | | Duration before end of effective | 1 | d |
|---|---|---|---|---|
| | | transmission | | |
| ContinuityCounter | | Is increased for every new MediaKey | 1 | d |
| Name | | Short Description | 1 | s |
| MediaIdentifier | Version number | Increases if content of MI is changed and | 1 | d |
| (MId) | | Repeat Counter is set to 0. | | |
| | Repeat Counter | Increases if content is transmitted again | 1 | d |
| | | without changes | | |
| | ContentID | ContentIdentifier; must be unique for the | 1 | s |
| | | content of MI | | |

| ContentCS | | | | 1 . . . n | s |
|---|---|---|---|---|---|
| LanguageCS | | | | 1 . . . n | d |
| MediaTypeCS | | | | 1 | d |
| Semantic | | | Describes the semantic meaning of the | 0 . . . 1 | s |
| | | | MediaItem based on properties like | | |
| | | | temporal resolution. | | |
| NumberOfLevels | | | Levels have to be consecutively. | 1 | s |
| | | | Maximum is 5. | | |
| For X=0; | LevelXMediaIdentifier | Version | Increases if content of MI is changed and | 1 | s |
| X<NumberOfLevels; | | number | Repeat Counter is set to 0. | | |
| X++; | | Repeat | Increases if content is transmitted again | 1 | s |
| | | Counter | without changes | | |
| | | ContentID | ContentIdentifier; must be unique for the | 1 | S |
| | | | content of MI | | |

| | | |
|---|---|---|
| LevelXSemantic | 0 . . . 1 | S |

Extended media key stream MKS_E

| Expire Time | | End of validity of this particular | 0 . . . 1 | d |
|---|---|---|---|---|
| | | MediaItem; no side effects to children; | | |
| | | now = delete immediately | | |
| | | if Expire Time is not used, the MediaItem | | |
| | | never expires | | |
| MediaIdentifier | Version number | Increases if content of MI is changed and | 1 | d |
| (MId) | | Repeat Counter is set to 0. | | |
| | Repeat Counter | Increases if content is transmitted again | 1 | d |
| | | without changes | | |
| | ContentID | ContentIdentifier; must be unique for the | 1 | s |
| | | content of MI | | |
| IntentionCS | | | 0 . . . n | d |
| FormatCS | | | 0 . . . 1 | d |
| IntendedAudienceCS | | | 0 . . . n | d |
| Abstract | Language | Long description; Abstract can occur more | 0 . . . n | d |
| | Abstract text | than once, but only once a language. | | |

| Semantic | | | Describes the semantic meaning of the | 0 . . . 1 | s |
|---|---|---|---|---|---|
| | | | MediaItem based on properties like | | |
| | | | temporal resolution. | | |
| NumberOfLevels | | | Levels have to be consecutively. Maximum | 1 | s |
| | | | is 5. | | |
| For X=0; | LevelX | Version | Increases if content of MI is changed and | 1 | s |
| X<NumberOf | MediaIdentifier | number | Repeat Counter is set to 0. | | |
| Levels; | | Repeat | Increases if content is transmitted again | 1 | s |
| X++; | | Counter | without changes | | |
| | | Content | ContentIdentifier; must be unique for the | 1 | S |
| | | ID | content of MI | | |

| | | |
|---|---|---|
| LevelXName | 0 . . . 1 | S |
| LevelXSemantic | 0 . . . 1 | S |

In some embodiments or in some situations of the above embodiments, it may not be possible to provide metadata or tagging data for a media stream without any delay and simultaneously with the broadcast. In other cases, the content provider may not be able to insert all data directly into the broadcast media stream. For this purpose, an additional Media Description MDI may be provided. Similar to the media key stream MKS, the MD may for example contain information on duration, expiry time, media identifier, and various descriptors related to the media content. A MD carrying this information may be transmitted after an actual media object transmission where a MediaIdentifier has already been assigned to the broadcast object. Then, the additional MD information together with the MediaIdentifier allows for matching the received parameters with prestored preferences and parameters. For example, a device may automatically record a media object which does not yet have complete MKS information. During or after the recording, the MD may be received and based on its content, the recording may be completed and the recorded object may be stored, or the recording may be cancelled/the media object may be deleted.

A MD may also be transmitted via a different transmission medium. For example, internet, short message service SMS, MMS, multimedia object transfer MOT, or any other transmission path may be used to convey the MD to a terminal. Some packet in the actual media stream, such as the PMT, may contain a reference to the location of the MD. The format of this location reference is dependent on the transport mechanism utilized, such as a website URL or a channel indication. An additional option based on the MD is that it can be used to split an already recorded content, where the split marks (based e.g. on interesting incidents) cannot be known at the time of transmission. An example is a live transmission of a sports game where interesting portions like goals or slow-motion replays can be tagged later as single objects, using the tagging information of an MD. In this way, a user would have the possibility to record a live soccer game, but only watch the tagged highlights later. Similar situations may arise, for example in a live transmission of a political debate where important statements can be tagged afterwards. Such an MD may be transmitted in the transport stream and/or on another medium.

TABLE 3
MDI parameters

| | | | | Dynamic |
|---|---|---|---|---|
| | | | | (d)/Static |
| Parameter | | Description | Occurency | (s) |
| Intended Duration | | Duration before end of effective | 1 | d |
| | | transmission | | |
| Name | | Short Description | 1 | s |
| Dataset Version number | | Version number of this | 1 | d |
| | | MediaDescription | | |
| Expire Time | | End of validity of this particular | 0 . . . 1 | d |
| | | MediaItem; no side effects to | | |
| | | children; | | |
| | | now = delete immediately | | |
| | | if Expire Time is not used, the | | |
| | | MediaItem never expires | | |
| MediaIdentifier (MId) | Version | Increases if content of MI is | 1 | d |
| | number | changed and Repeat Counter is | | |
| | | set to 0. | | |
| | Repeat | Increases if content is transmitted | 1 | d |
| | Counter | again without changes | | |
| | ContentID | ContentIdentifier; must be unique | 1 | s |
| | | for the content of MI | | |
| IntentionCS | | | 0 . . . n | d |
| FormatCS | | | 0 . . . 1 | d |
| ContentCS | | | 1 . . . n | s |
| IntendedAudienceCS | | | 0 . . . n | d |
| LanguageCS | | | 1 . . . n | d |
| MediaTypeCS | | | 1 | d |
| Abstract | Language | Long description; Abstract can | 1 . . . n | d |
| | Abstract text | occur more than once, but only | | |
| | | once a language. | | |
| Description | Key | Key-/Value Pairs describing | 0 . . . n | d |
| | Value | specific properties of the | | |
| | | MediaItem. Some keys will be | | |
| | | predefined (e.g. song title, movie | | |
| | | title, music composer) while others | | |
| | | can be defined by the content | | |
| | | provider. | | |
| Children | Version number | Increases if content of MI is | 0 . . . n | d |
| MediaIdentifier | | changed and Repeat Counter is | | |
| (MId of the children) | | set to 0. | | |
| | Repeat Counter | Increases if content is transmitted | | |
| | | again without changes | | |
| | ContentID | ContentIdentifier; must be unique | | |
| | | for the content of MI | | |
| SourceReference | Type | Identifier for the type of source | 0 . . . n | d |
| | | (e.g. DAB, DMB, DVB-H, . . . .) | | |
| | Access information | Describes the access to the | | |
| | | source. Must be defined for every | | |
| | | system individually; MKS ID can | | |
| | | be specified if multiple MKS exist | | |
| Composition | Type | Identifier for the type of | 0 . . . 1 | d |
| | | composition (e.g. list, pool, | | |
| | | priority, . . . .) | | |
| | Information | Necessary parameters for a | | |
| | | composition | | |
| Editorial Origin | | Name of the editorial department | 0 . . . 1 | s |

The MD may also be used to describe a hierarchical structure of several media items and provide a mechanism for grouping several items together. An example for this is to group all media objects of a newscast and thus provide the original program flow later on. The Composition parameter within the MDI can be used by the content provider to offer a set of background material referring to a particular broadcast item. This can be a referrer to a website with in-depth information which is too specific to be included into the broadcast stream. Users can thus access information without the need to search for it and content providers do not loose users to other content providers. As the Tagging metadata is carried through the system independent of the video/audio data, it can be scrambled separately and can be charged as a separate pay service. It is possible to provide the broadcast stream free-to-air and charge for the tagging service. Scrambling has to be provided by the underlying transmission system, e.g. for MPEG-based systems only the PIDs in the Transport stream that are carrying Tagging information are scrambled.

Exemplary MD parameters are shown in Table 3.

In another embodiment of the invention, an additional media recording forecast MRF may be provided. This data element may be used for determining in advance whether any media objects of interest will be transmitted within a certain period of time. For example, the MRF may be transmitted regularly within the media stream, and a receiver may receive and process the received MRF in predetermined intervals of e.g. one hour. From the parameters included in the media recording forecast, the receiver may match the categories and content parameters with stored user preferences and may then decide based on this matching whether the receiving unit may be switched off for a certain period of time. When a media object of interest is scheduled half an hour after the received forecast MRF, the receiver may (based on settings) switch on and start decoding in sufficient time before the program item is actually broadcasted. In this way, the receiver may record all desired media objects based on the forecast of future media content, and save power by switching the receiver off when no recording is required. In particular mobile devices with limited power supply (e.g. a rechargeable battery) may benefit from such a power saving function. In other embodiments, the forecast information may simply be used for preparing a recording with sufficient time ahead, without switching the receiver off in between. For example, the information may be used to provide sufficient storage space in memory for a certain media object previous to recording. The interval at which the receiver is switched on automatically for receiving the MRF may be preset and optionally be defined by user settings. After receipt and matching of the MRF data, the terminal may either go back into standby mode when no recordings are desired, or schedule its switching on for a specific media object to be received. The receiver may be activated slightly before the relevant broadcast and then monitor the received stream for the exact start given in the MKS, as described above. Table 4 shows a number of exemplary parameters and features that may be included in a MRF.

TABLE 4
MRF parameters

| | | | | Dynamic |
|---|---|---|---|---|
| Parameter | | Description | Occurency | (d)/Static (s) |
| LocatorID | Type | Identifier for Broadcast system (e.g. | 1 | d |
| | | DAB, DMB, DVB-H, . . . .) | | |
| | Identifier | A unique Service Identifier (See | | |
| | | DAB/DVB-H spec) | | |

| | | | |
|---|---|---|---|
| Planned Broadcast Start | Forecast of the time of transmission | 1 | d |
| Time | | of a MI | |
| IntendedDuration | Duration before end of effective | 1 | d |
| | transmission | | |
| IntentionCS | See TVASpec | 0 . . . 1 | d |
| FormatCS | See TVASpec | 0 . . . 1 | d |
| ContentCS | See TVASpec | 1 . . . n | s |
| IntendedAudienceCS | See TVASpec | 0 . . . n | d |
| LanguageCS | See TVASpec | 0 . . . n | d |
| MediaTypeCS | See TVASpec | 1 | d |
| MID Version number | Increases if content of MI is | 1 | s |
| | changed. Refers to same value in | | |
| | MKS | | |
| MID ContentID | ContentIdentifier; must be unique | 1 | s |
| | for the content of MI. Refers to | | |
| | same value in MKS | | |

In general, the information provided in MKS, MRF and MDI may be utilized for various purposes. First of all, it is possible to decide which media objects to record at all (or, in case of a subsequently transmitted MDI, which objects to keep stored). The decision may be made on basis of a comparison of transmitted media object parameters and stored user preferences. For example, a user may define sports and documentary as categories of interest. It is also possible to provide a hierarchy of categories, allowing to refine the category selection. The exact structure of the categories and parameter is not essential, and the person skilled in the art will easily be able to modify the categories given as examples here. A media object may for example be characterized by an “intention” descriptor, defining whether a program is intended for entertainment, education, information, retail, advertisement or similar categories. In each of these categories, subcategories may also be defined, such as adult education and youth education for an education category, or current information and advice information for the information category. Another descriptor may be a “content” descriptor, giving more detailed information about the actual content of the described media object. For example, one of the categories may (again) be information, and subcategories might then be “daily news”, “sports” or “business news”. The hierarchical depth may also be more complex than shown in this example. Further potential descriptors include a “format” descriptor for defining a program format (such as talk show, moderated news, news clips, etc.); an “intended audience” descriptor defining target groups based e.g. on age, social groups, occupational background, or regional origin; a “language” descriptor indicating the language of the media object; and a “media type” defining the type of broadcast media, such as video, audio only, multimedia content, interactive content, and so on. This exemplary list of categories, subcategories and descriptors is not intended to be exhausting and may include more, less, or different characteristics.

The categories allow a user to define his interest in more or less detail, as desired. A user preference “sport” may lead to recording of any newscast, entertainment show, live transmission and/or documentary related to sports in general. Another user may specify that he is only interested in current basketball results, and the recordings will therefore include any basketball live transmission and newscast objects for this topic. Several parameters and categories may be combined as desired to allow an optimized choice of content. An automatic or partially automatic preference system may optionally be included in a terminal device for determining user preferences. For example, after a user has defined several times that he wants to record/see the daily weather forecast for his region, the preference system may automatically adjust the stored interest preferences to always include the weather forecast. Alternatively, the system may perform some kind of user dialog for confirming this detected preference.

Once media objects have been recorded based on these preferences, the objects may be further processed in the terminal. Again, this processing may be performed based on the same or on different user preferences. For example, a user may define that at night he likes to view a compilation of all political news items recorded during the day together with the basketball results. As another program, the user may define a combination of music clips recorded on several days. In this way, a user (or once more the terminal itself) is able to provide custom-made media channels based on current broadcast content. A user may also be allowed to rearrange a preformed channel as he desires, such as viewing sports results first although he usually likes to get political information first. Various user input means might be used for simply shifting objects back and forth on a display screen. Media objects that are now combined in a user-specific channel may also have been received from different sources, at different times, or even on different transmission paths. It is also conceivable to combine recorded broadcast media with other media stored on a terminal, such as music files stored in a local file repository, pictures that have been retrieved from a digital camera, or podcasts downloaded from the interne. Each of these media files may be treated as a media object similar to those that have been recorded from the broadcast stream. Another option is to allow third-party services to create rules for composing a media channel, which may for example be obtained in a pay service. A user may subscribe to a service that provides certain rules (similar to a play list for media players) for e.g. combining a daily business channel, or a channel related to a unique event such as a world championship. Another example for third-party channel rules is that advertisements or sponsor notes may be added automatically at the beginning of a recording. Alternatively, the content provider may set a media object such that an advertisement is automatically included in the object by defining the object boundaries accordingly.

An important feature of tagged broadcast media is that recorded items and custom channels may be kept up to date very easily. A media object such as the weather forecast may be provided with a version number, and when the forecast is transmitted again with a slightly different content after half an hour, the terminal may discard the previous weather forecast recording and replace it by a newer one. The version that is currently stored is also indicated by a version number stored with the content information of a media object. Also, abstract schedules defined for a personal channel such as business news, sports news and then the daily soap opera episode may be filled with up-to-date content every day anew. It may be user defined or object-specific for how long an object is stored on the terminal.

Using the above features, it is possible to define at least two operational profiles for a receiver terminal. The different profiles may be signaled and thus allow a receiver to decide whether the services can be decoded or not. In a first profile, the metadata and media content is transmitted simultaneously as already described above. The receiver in profile 1 monitors the broadcast data and starts to record the audio/video stream as soon as a program item within a relevant category is signaled. All metadata needs to be transferred essentially without delay to the terminal to allow controlling the recordings. A split MKS as described above may be used for fast delivery of all relevant time critical information. The transport stream or a similar data stream is used for transmitting MRF and MKS information to a terminal. MRF and MKS are arranged in sections, and separate PIDs are defined for MRF and MKS. A table such as MRF or MKS is transmitted as one or more table sections. The first field in the table section is the table ID, which allows the receiver to identify all of the sections for a table so that the receiver can reconstruct the complete table data structure. The table ID allows multiple tables to be transmitted in a single PID stream. For the MRF, one table ID will be given for the actually received transport stream, and different table IDs are provided for other transport streams. As mentioned above, at least the basic MKS is transmitted in short intervals of e.g. 500 ms in order to define precise starting and end points of media objects. A time reference is given by the continuity counter value in the MKS. It is also possible to provide multiple MRFs and MKSs having separate PIDs, with the continuity counter being synchronized. An identifier MKS_ID for each MKS is then mandatory in the PMT elementary stream, providing an indication for deciding which MKS to use. The decision may at least in part be based on receiver capabilities. When MKS and/or MRF are scrambled within the stream, a certificate authority CA descriptor is required for these streams.

The second profile is directed to the delayed and non-simultaneous insertion of metadata into a stream, or the external providing of metadata via an MDI. The general principle of this embodiment has been described above. As mentioned, the MDI may be transmitted within the same transport stream, during or after transmission of the media object in question; or it may alternatively be provided on another transmission medium, such as the internet. A precondition for this profile is that the time bases of receiver and broadcast station have to be synchronized, which may be achieved by inserting timestamps into the stream referring to the broadcast station time base. The timestamps may be inserted by the tagging unit at the broadcast side. The receiver may then store a certain amount of recorded content and edit and sort this content after receiving the corresponding MDI from the transport stream or another source. In this way, even a third-party provider may provide the tagging data without having access to the actual media stream. The MDI location may be indicated within the PMT of the transport stream, the actual format depending on the transmission mechanism used for the MDI. Further parameters may be included in the MDI, such as the origin of the file, or version information for each MD binary. Multiple MDIs may be provided for a single service.

It may be device dependent whether a receiver supports only one of the profiles, both profiles, or even further modified profiles not described here. A simple receiver which is only able to monitor the broadcast channel may only support the first profile with simultaneous metadata extraction, while a receiver with e.g. WLAN or UMTS support may additionally be able to support the second profile by retrieving the MD information from another source.

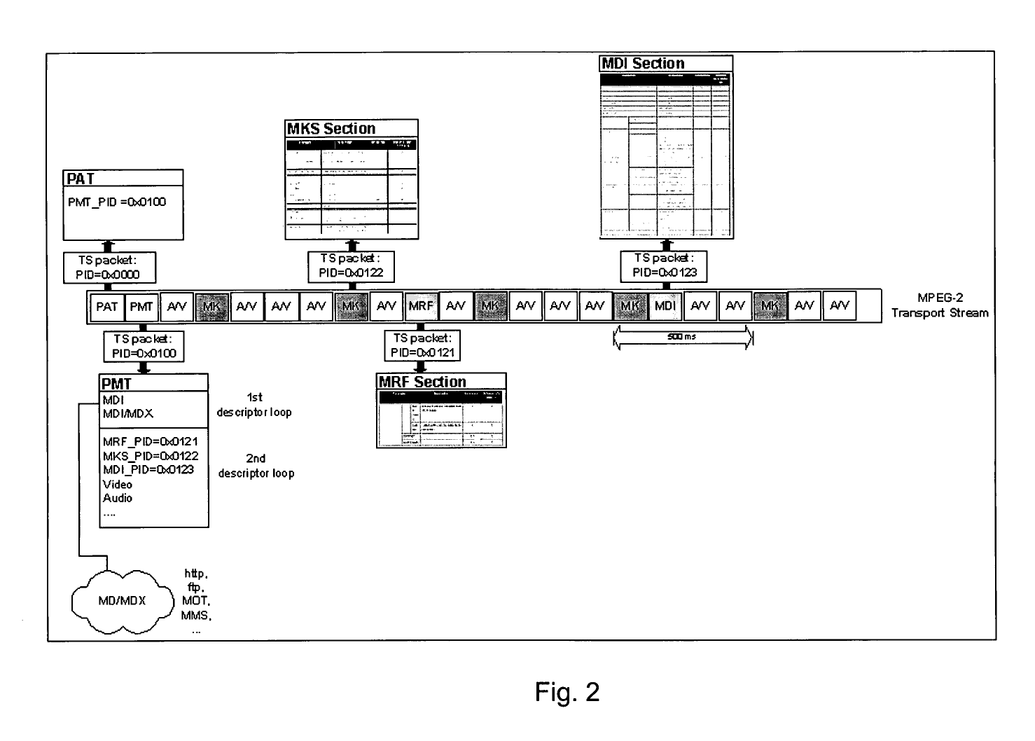

FIG. 2 is a schematic illustration of a transport stream according to an inventive embodiment. The first transport stream packet includes the program association table PAT, which gives the packet identifier PID of all program map tables PMT in the stream. In the example of FIG. 2, the PID of the only PMT is 0x0100. This PMT in turn indicates the PIDs of the following program, including the PIDs of video and audio packets, and of packets including metadata or other data related to the stream such as the MRF, MKS and MDI transmitted in the transport stream. When no MDI is transmitted in the transport stream, this indication is of course left out. These elements are given in the second (or inner) descriptor loop, while in the first (or outer) descriptor loop of the PMT a location reference or another indication of an external MDI may be given, as explained above. Using the PIDs given in the program map table, the receiver will be able to extract the MKS, MRF and/or MDI from the broadcast stream and to record and sort the received media. As shown in FIG. 2, every fourth packet (every 500 ms) is a MKS to achieve precision timing. The MRFs do not have to be transmitted as often and also not in such regular intervals. It is sufficient to transmit MRFs such that a power-saving receiver has a chance to receive the MRF within its preset activation interval. It shall also be noticed that the amount of tagging data is small compared with the actual media data, such that the live streaming character is not affected.

In the above exemplary embodiments, the invention has been described with reference to a DMB system using a MPEG transport stream. However, it is evident that the invention may be applied similarly to other broadcasting systems, and to other transport formats besides MPEG. The adaptation of streams, packets and parameter tables from the examples to another system will be easy for those skilled in the art. A synchronized insertion of metadata may be achieved in many transmission systems by dividing the metadata to be included into time critical and non-time critical portions. Also, a reference to an external media description for subsequent stream splitting may be included in a stream in any desired way.

Although exemplary embodiments of the present invention have been described, these should not be construed to limit the scope of the invention. Those skilled in the art will understand that various modifications may be made to the described embodiments and that numerous other configurations or combinations of any of the embodiments are capable of achieving this same result. Moreover, to those skilled in the various arts, the invention itself will suggest solutions to other tasks and adaptations for other applications. It is the applicant's intention to cover all such uses of the invention and those changes and modifications which could be made to the embodiments of the invention herein chosen for the purpose of disclosure.

1-41. (canceled)

42. A method comprising:
receiving a broadcast media stream including metadata information associated to portions of said media stream,
extracting said metadata information from said media stream,
utilizing said metadata information by comparing metadata parameters to stored parameters, and
recording a portion of said media stream forming a media object in response to a match in said comparing metadata parameters to stored parameters,
wherein said metadata information comprise a first parameter set that includes time-critical portions comprising at least a duration of said media object and at least one machine readable content descriptor inserted in regular interval within said media stream, and a second parameter set that includes non-time critical portions relating to said media object.

43. The method of claim 42, wherein said regular interval is about 500 ms.

44. The method of claim 42, wherein said media object is stored together with at least a part of said associated metadata parameters.

45. The method of claim 42, wherein said comparing metadata parameters to stored parameters comprises:
comparing metadata parameters of said first parameter set to said stored parameters,
recording a portion of said media stream forming a media object in response to a match in said comparing metadata parameters of said first parameter set to said stored parameters,
comparing metadata parameters of said second parameter set to said stored parameters, and
continuing or cancelling said recording in response to said comparing metadata parameters of said second parameter set to said stored parameters.

46. The method of claim 42, wherein said metadata information includes a location reference for a media description file.

47. The method of claim 46, said utilizing of said metadata information further comprising
extracting said location reference, and
retrieving said media description file from said location reference.

48. The method of claim 47, further comprising establishing a transmission connection to a location indicated in said location reference.

49. The method of claim 46, further comprising
comparing metadata parameters of said media description file to said stored parameters, and
recording a portion of said media stream forming a media object in response to a match in said comparing metadata parameters of said media description file to said stored parameters.

50. The method of claim 46, further comprising
comparing parameters of said media description file to said stored parameters, and
determining whether to keep or discard a stored media object based on said media description file.

51. The method of claim 46, further comprising dividing a recorded media object into several smaller media objects in accordance with parameters indicated in said media description file.

52. The method of claim 42, further comprising
extracting a media recording forecast from said metadata information, and
scheduling a recording of one or more media objects based on said media recording forecast, said scheduling comprising comparing parameters of said media recording forecast to stored parameters.

53. The method of claim 52, further comprising deactivating at least a receiver unit until the next scheduled recording.

54. The method of claim 53, further comprising
activating said receiver unit in predetermined intervals, and
awaiting and receiving said media recording forecast.

55. The method of claim 53, further comprising maintaining said receiver unit without deactivation if a recording is scheduled within a predetermined period of time.

56. The method of claim 53, further comprising reactivating said receiver unit for receiving and encoding said media stream slightly before the start time of said scheduled media object to be recorded.

57. The method of claim 42, further comprising sorting recorded media object by matching said associated metadata for said media objects to preset preferences, wherein said preset preferences are provided by an external service provider and/or determined based on previous user behavior and/or set by user input.

58. A method comprising:
providing a stream including media content for broadcasting including one or more media objects having a predetermined duration and content,
providing metadata related to said media objects,
broadcasting said stream together with at least a part of said metadata, wherein at least a part of said metadata is inserted into the stream in regular intervals, and
dividing said metadata into at least two parameter sets, wherein a first parameter set that includes at least a machine readable duration and content descriptor is transmitted in said regular intervals, and a second parameter set includes non-time critical metadata information related to said media objects.

59. The method of claim 58, further comprising
providing forecast metadata related to media content which is scheduled to be broadcast within a predetermined upcoming time period,
broadcasting said forecast metadata within said stream, and
including a location reference into said metadata pointing to an external media description file location.

60. The method of claim 59, further comprising providing and transmitting metadata related to at least one media object which has already been broadcast, wherein said metadata includes a unique identifier for identifying said media object.

61. A system for media broadcast tagging comprising
a broadcast station including
a transmission unit adapted to transmit media content in a stream,
a tagging unit adapted to provide metadata related to said media content and to insert at least part of said metadata into said stream at regular intervals; and
at least one receiving terminal including
a receiving unit adapted to receive said broadcast stream,
a recording unit adapted to obtain said metadata from said broadcast stream, and
a storage element for storing selected of said received media content in response to said metadata.
